(19) United States
(12) Patent Application Publication
(10) Pub. No.: US 2007/0132571 A1
(43) Pub. Date: Jun. 14, 2007

(54) Warning system for detecting presence of a child in a vehicle

(76) Inventor: Marc A. Rossi, West Palm Beach, FL (US)

Correspondence Address: ROSSI, KIMMS & McDOWELL LLP., P.O. BOX 826, ASHBURN, VA, 20146-0826, US

(21) Appl. No.: 11/299,277

(22) Filed: Dec. 9, 2005

(51) Int. Cl. B60Q 1/00; G08B 23/00

(52) U.S. Cl. 340/457; 340/573.4

(57) ABSTRACT

A warning system detects the presence of a child within a vehicle that doesn't rely on the detection of vehicle ignition state to generate an alarm. The warning system is capable of operation within any type of vehicle and could be easily transported from one vehicle to another. The warning system preferably includes a control unit, a first occupant sensor coupled to the control unit, and a second occupant sensor coupled to the control unit. The control unit generates an alarm when the first occupant sensor detects the presence of an occupant and the second occupant sensor does not detect the presence of an occupant. The alarm continues until the second occupant is seated.

### BACKGROUND

The present invention is directed to a system for detecting the presence of a child within a vehicle. Specifically, the system generates an alarm when a child has been left in a vehicle without the driver present.

A number of children die each year due to being left unattended in a vehicle. Cases have occurred, for example, in which infants have been left all day in their car seats after their parents had failed to drop them off at a babysitter or daycare on their way to work. In hot weather, the children often succumb to dehydration and heat exhaustion due to the extremely high temperatures that can be reached in a closed vehicle. The problem, however, is not just limited to hot weather, as deaths have also occurred due to children freezing from the cold during winter months.

Pioneering efforts to solve the problem of children being left unattended in their car seats included a system as described in U.S. Pat. No. 5,949,340 in which sensors are used to detect the presence of a child in an infant seat and also to detect the state of the vehicle's ignition. In the event that a child is left in the infant seat and the ignition is changed from an “on” state to an “off” state, a warning signal is generated to remind the vehicle's drive to remove the infant from the car seat. Further refinements of the system were described in U.S. Pat. No. 6,104,293.

Since the pioneering work described above, a number of others have proposed additional modifications of the basic concept. However, none of these systems has yet to be adopted in the commercial marketplace. Accordingly, children continue to die each year when a simple solution could be implemented to improve their chances of survival.

The present invention is based, in part, on the realization that commercialization of a warning system has been impeded due to the necessity of detecting the ignition state of the vehicle. The requirement to detect the ignition state of the vehicle adds complexity to the overall system, as the warning system must be either physically hard wired to the electrical system of the vehicle or a wireless transmitter must be coupled to the electrical system to send out a signal indicative of ignition state. Due to variations in wiring and electrical systems in vehicles, it is difficult to develop a warning system product that can be easily implemented across all vehicle lines. In addition, incorporating a sensor within an infant seat requires the cooperation of seat manufacturers.

In view of the above, it would be desirable to provide a warning system for detecting the presence of a child within a vehicle that doesn't rely on the detection of vehicle ignition state to generate an alarm. It would further be desirable to provide such a warning system that was capable of operating within any type of vehicle and could be easily transported from one vehicle to another.

### SUMMARY OF THE INVENTION

The present invention provides a warning system for detecting the presence of a child within a vehicle that doesn't rely on the detection of vehicle ignition state to generate an alarm. The warning system is capable of operation within any type of vehicle and could be easily transported from one vehicle to another.

The warning system preferably includes a control unit, a first occupant sensor coupled to the control unit, and a second occupant sensor coupled to the control unit. The control unit generates an alarm when the first occupant sensor detects the presence of an occupant and the second occupant sensor does not detect the presence of an occupant, preferably by utilizing a first occupant sensor that provides a normally open circuit condition and a second occupant sensor provides a normally closed circuit condition.

The control unit preferably includes a rechargeable electrical power source coupled to an alarm circuit, with the electrical power source, the alarm circuit, the first occupant sensor and the second occupant sensor preferably connected in series. Accordingly, an alarm is generated when the first occupant sensor detects the presence of an occupant, and the alarm continues until the second occupant sensor detects the presence of an occupant.

The alarm circuit includes either an audible alarm, a visual alarm or both an audible alarm and a visual alarm. The audible and visual alarms can be included within the control circuit or be provided as separate devices that can plug into the control circuit.

In just one example, a visual alarm is provided that can be coupled to the vehicle by a mechanism such as a suction cup. The visual alarm includes a visual alarm indicator, preferably a flashing light, which can draw attention to the vehicle in the event the vehicle driver ignores the alarm.

In one illustrated example, the first occupant sensor and the second occupant sensor are respectively provided in first and second seat pads. The first seat pad, to be employed in a child car seat, is preferably smaller than the second seat pad, which is to be located in the vehicle's driver's seat. The first occupant sensor and the second occupant sensor may include: a mechanical sensor, an optical sensor, an ultrasonic sensor or a pressure sensor.

### BRIEF DESCRIPTION OF THE DRAWINGS

The invention will now be described with reference to certain preferred embodiments thereof and the accompanying drawings, wherein:

FIG. 1 illustrates a schematic block diagram of a warning system in accordance with the invention;

FIG. 2 illustrates an electrical schematic block diagram of a warning system in accordance with the invention; and

FIG. 3 illustrates a preferred embodiment of the inventive warning system incorporating the use of seat pads.

### DETAILED DESCRIPTION OF THE PREFERRED EMBODIMENTS

A warning system in accordance with the invention is shown in FIG. 1 as including a first occupant sensor 10 and a second occupant sensor 12, each of which are connected to a control unit 14. The control unit 14 includes an electrical power source 16 and an alarm circuit 18. In the simplest case, the alarm circuit 18 includes an audible alarm device 20 and a visual alarm device 22, although only one alarm device may be employed if desired. The first occupant sensor 10 and the second occupant sensor 12 can be any type of sensor capable of detecting the presence of an individual including, but not limited to, a mechanical switch, a pressure sensing device, an optical sensor, an ultrasonic sensor and a temperature sensor. For purposes of illustration, the first occupant sensor 10 and the second occupant sensor 12 will be considered to be simple mechanical switching devices.

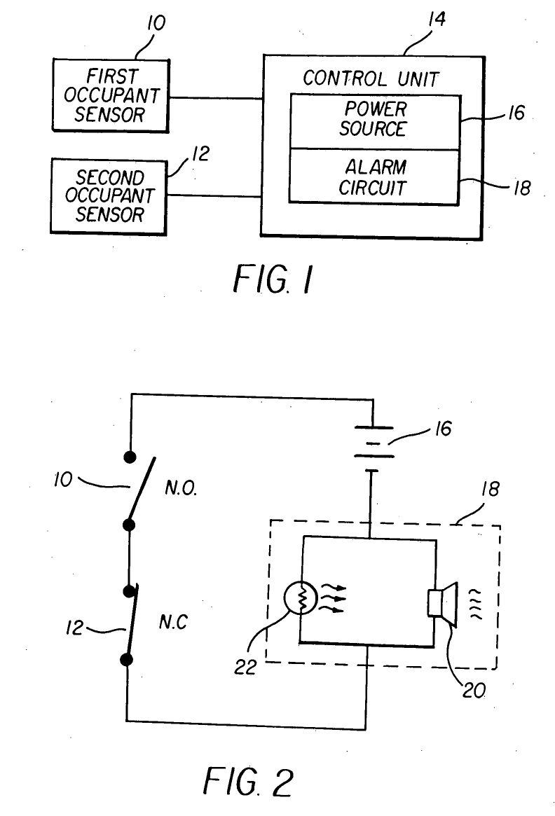

FIG. 2 illustrates a basic electrical schematic diagram for the system illustrated in FIG. 1. The first occupant sensor 10, which in the illustrated example will be designated the child occupant sensor, is a normally open (N.O.) circuit device, which means that an open circuit is provided when a child is not detected and a closed circuit is provided when a child is detected. The second occupant sensor 12, which in the illustrated example will be designated the vehicle driver's occupant sensor, is a normally closed (N.C.) circuit device, which means that a closed circuit is provided when the vehicle drive is not detected and an open circuit is provided when the vehicle driver is detected. The first occupant sensor 10 and the second occupant sensor 12 are preferably coupled in series with the electrical power source 16 and the alarm circuit 18 (although other circuit arrangements may be employed), such that when no occupants are detected the first occupant sensor 10 provides an open circuit preventing the alarm circuit 18 from being activated. When a child is detected in the vehicle by the first occupant sensor 10, however, the circuit is closed causing the alarm circuit 18 to be activated. An audible alarm, for example a simple buzz, ring or chime or even a voice generated signal, is generated by the audible alarm device 20. Similarly, the visual alarm device 22, for example a simple LED indicator, light bulb or strobe light, is activated to generate a visual alarm. The alarms remain active until the second occupant sensor 12 detects the presence of the vehicle driver, at which point the second occupant sensor 12 generates an open circuit condition causing the alarm circuit 18 to be deactivated.

In operation, the first occupant sensor 10 is preferably placed or located in, near or around a child's car seat in a position enabling the first occupant sensor 10 to detect the presence of a child in the car seat. The second occupant sensor 12 is preferably placed or located in, near or around the vehicle driver's seat in a position enabling the second occupant sensor 12 to detect the presence of the vehicle driver in the vehicle driver's seat. When the child is placed in the child's car seat, the warning system is activated (first occupant sensor 10 closes circuit) and begins generating at least one of an audible alarm or a visual alarm. The alarm will continue until the vehicle driver sits in the vehicle driver's seat (second occupant sensor 12 opens circuit), at which point the warning system is deactivated. When a destination is reached, the vehicle driver leaves their seat (second occupant sensor 12 closes circuit) causing the warning system to be activated once again. An alarm will be generated until the child is removed from the child's car seat (first occupant sensor 10 opens circuit), thereby greatly reducing the possibility that the child will be left unattended in the vehicle.

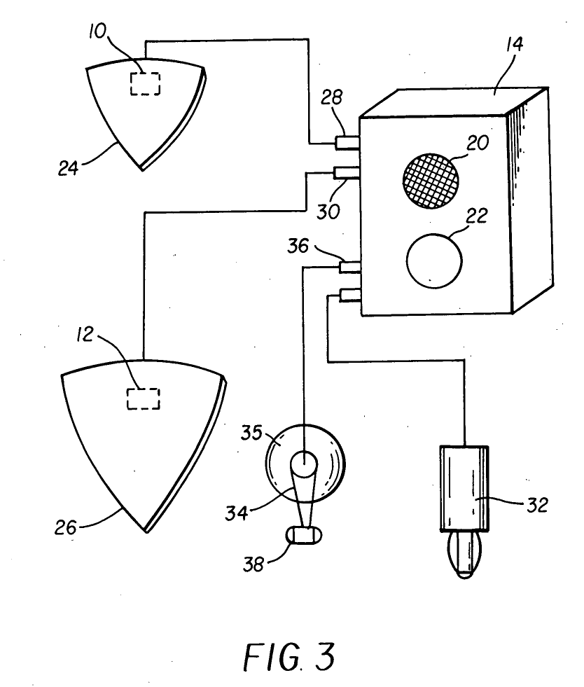

FIG. 3 illustrates just one preferred embodiment of the inventive warning system. As shown in FIG. 3, the first occupant sensor 10 and the second occupant sensor 12 are respectively embedded, placed or located within a first seat pad 24 and a second seat pad 26. In the illustrated example, the first seat pad 24 is larger than the second seat pad 26 so that it may more readily be placed at the bottom of an infant or child car seat. The second seat pad 26 is placed in the vehicle's driver seat. The first and second seat pads 24, 26 are preferably detachably connected to the control unit 14 with detachable connectors 28, 30. If desired, patches of hook and loop fasteners, straps or other retention mechanisms (not shown) can be provided to secure the first and second seat pads 24, 26 to the child seat and the driver's seat. In the embodiment illustrated in FIG. 3, a connector 32 is also provided to allow the control unit 14 to be plugged into the vehicle's electrical system to enable operation directly from the vehicle's electrical system or recharging of the electrical power source 16.

The first and second seat pads 24, 26 are preferably gell type seat pads in order to provide some additional cushioning. However, the seat pads 24, 26 can be as simple as a single layer of material to which the occupant sensors are attached. The primary function of the seat pads 24, 26 to provide a mechanism for locating the occupant sensors in a desired position within the child seat and the vehicle drivers seat in the event the occupant sensors are of a type requiring the occupant to directly sit on them.

The embodiment illustrated in FIG. 3 shows the audible alarm 20 and the visual alarm 22 being incorporated into the body of the control unit 14. It should be understood, however, that the alarm devices can be separate from the control unit 14. As one example further illustrated in FIG. 3, a visual alarm 34 is shown that is connected to the control unit 14 with a detachable connector 36. In this example, the visual alarm 34 includes a mechanism 36 for attaching the visual alarm 34 to the vehicle and a visual alarm indicator 38. In the illustrated example, mechanism 36 is preferably a suction cup and the visual alarm indicator 38 produces a flashing light. The suction cup mechanism 36 can be used to attach the visual alarm 34 to a window of the vehicle at a location most conspicuous to individuals passing by the vehicle. Accordingly, in the event that the vehicle driver should ignore the warning when leaving the vehicle, the visual alarm indicator 38 is likely to draw attention to the vehicle so that appropriate officials can be notified of the presence of the child within. A separate audible alarm can be similarly provided.

The invention has been described with reference to certain preferred embodiments thereof. It will be understood, however, that modifications and variations are possible within the scope of the appended claims. For example, although the illustrated example shows the use of hard wiring between the occupant sensors and the control unit, wireless devices may be readily employed. Further, the occupant sensors need not be incorporated into a seat pad, but can simply be placed in any manner at any location suitable to detect the presence of occupants. For example, in the case of optical or ultrasonic devices, the occupant sensor may be attached to the roof of the vehicle at a location above the occupant seats. Timers may also be incorporated to allow time delays before the activation of the alarms. In addition, the electrically layout of the circuitry may vary, for example, the electrical power source or the alarm circuit could be wired in series between the occupant sensors and still have the same effect. It should be understood that the invention is in no way limited to the disclosed circuit design, as those skilled in the art can use a variety of hardware, software, firmware and logic elements to accomplish the same function. The only requirement of the control circuit is to generate an alarm when a child is detected and to discontinue an alarm when the driver is detected without reliance on the ignition state of the vehicle. Accordingly, the examples provided above ate clearly only illustrative examples of possible circuit designs within the scope of the invention.

As will be readily appreciated by those skilled in the art, the warning system is extremely simple in design, can be inexpensively manufactured, can be utilized in any vehicle without requiring detection of the vehicles ignition state, and can be readily moved from one vehicle to another as required. Of primary importance is the ability to manufacture the warning system without the cooperation of either vehicle manufacturers or child seat manufactures, namely, the warning system is a separate stand alone system that is independent of vehicle or car seat design.

What is claimed is:

1. A warning system comprising:
a control unit;
a first occupant sensor coupled to the control unit;
a second occupant sensor coupled to the control unit;
wherein the control unit generates an alarm when the first occupant sensor detects the presence of an occupant and the second occupant sensor does not detect the presence of an occupant.

2. A warning system as claimed in claim 1, wherein the first occupant sensor provides a normally open circuit condition and the second occupant sensor provides a normally closed circuit condition.

3. A warning system as claimed in claim 2, wherein the control unit includes an electrical power source coupled to an alarm circuit.

4. A warning system as claimed in claim 3, wherein the electrical power source, the alarm circuit, the first occupant sensor and the second occupant sensor are connected in series.

5. A warning system as claimed in claim 3, further comprising an electrical connector coupled to the control unit that is capable of connecting with the electrical system of a vehicle.

6. A warning system as claimed in claim 3, wherein the alarm circuit includes an audible alarm or a visual alarm.

7. A warning system as claimed in claim 1, wherein the first occupant sensor and the second occupant sensor are respectively provided in first and second seat pads.

8. A warning system as claimed in claim 7, wherein the first seat pad is smaller than the second seat pad.

9. A warning system as claimed in claim 1, wherein one of the first occupant sensor and the second occupant sensor comprises a mechanical switch.

10. A warning system as claimed in claim 1, wherein one of the first occupant sensor and the second occupant sensor comprises an optical sensor.

11. A warning system as claimed in claim 1, wherein one of the first occupant sensor and the second occupant sensor comprises an ultrasonic sensor.

12. A warning system as claimed in claim 1, wherein one of the first occupant sensor and the second occupant sensor comprises a pressure sensor.

13. A warning system as claimed in claim 1, further comprising a visual alarm coupled to the control unit, wherein the visual alarm includes a mechanism for attaching the visual alarm to the vehicle and a visual alarm indicator.

14. A warning system as claimed in claim 13, wherein the mechanism for attaching the visual alarm to the vehicle comprises a suction cup.

15. A warning system as claimed in claim 13, wherein the visual alarm indicator comprises a flashing light.
